(19) United States
(12) Patent Application Publication
(10) Pub. No.: US 2019/0102390 A1
(43) Pub. Date: Apr. 4, 2019

(54) SEMANTIC SEARCH ENGINE AND VISUALIZATION PLATFORM

(71) Applicant: NOVABASE SGPS, S.A., Lisboa (PT)

(72) Inventors: Bruno ANTUNES, Sao Silvestre (PT); Pedro VERRUMA, Coimbra (PT); Ricardo QUINTAS, Elvas (PT); João LEAL, Aveiro (PT); Sara PINTO, Oliveirinha (PT); Tiago MATEUS, Santa Comba Dao (PT)

(21) Appl. No.: 15/720,662

(22) Filed: Sep. 29, 2017

(51) Int. Cl. G06F 17/30; G06F 17/27

(52) U.S. Cl. CPC G06F 17/3043; G06F 17/277; G06F 17/30991; G06F 17/2785; G06F 17/30864; G06F 17/278

(57) ABSTRACT

Disclosed herein are systems, devices, and methods for translating natural language queries into data source-specific structured queries and automatically identifying visualization options based on the result of executing a structured query. In one embodiment, a method comprises receiving a natural language query; generating one or more interpretations based on the natural language query using one or more natural language processing procedures; generating a structured query based on the one or more interpretations, the structured query generated based on an identified data source type; executing a search on the data source using the structured query, the execution of the search resulting a result set; identifying a visualization type based on a type of data included within the result set; and generating a visualization based on the visualization type and the result set.

### BACKGROUND

The disclosure relates to the field of search engines and data visualization and, in particular, to systems, methods, and devices for enabling natural language searching of structured data and automatically identifying visualizations for queried data.

With the explosive and continued growth of data, both within corporate networks and via the global Internet, various techniques have been proposed to retrieve and display of data. Most commonly, data is often retrievable via a search engine which maintains a listing of documents and a searchable index (e.g., an index of words appearing in the listing of documents). Certain search engines additionally are configured to perform various operations on incoming queries to “rephrase” the queries to formulate alternative queries (e.g., replacing “films” with “movies” and using “movies” as a query term). Additionally, some search engines are capable of “responding” to questions by generating search terms from the question and extracting an answer to the question using the search terms.

Notably, these systems only perform rudimentary language processing of search queries and are limited in only providing generic results for simplified queries. These systems additionally fail to provide a robust mapping of natural language queries to structured search instructions. Moreover, each of these systems are limited to simplistic document retrieval operations and, optionally, parsing. Finally, these systems generally fail to perform any significant visualization of data in response to user queries. Thus, current systems fail to provide robust natural language processing of search queries, fail to allow access to remote data sources, and fail to provide adequate visualization of search results based on identified data.

### BRIEF SUMMARY

The disclosed embodiments describe systems, devices, and methods for translating natural language queries into data source-specific structured queries and automatically identifying visualization options based on the result of executing a structured query.

The disclosed embodiments address the problems in current systems, described above. Specifically, the disclosed embodiments describe new techniques (and corresponding devices and systems) for parsing natural language queries, extracting an interpretation of the queries, and translating the interpretation into structured queries. The disclosed embodiments further describe novel techniques for automatically executing internal representations of network queries on external data sources as well as automatically selecting appropriate visualizations based on the underlying data.

In one embodiment, a method comprises receiving a natural language query; generating one or more interpretations based on the natural language query using one or more natural language processing procedures; generating a structured query based on the one or more interpretations, the structured query generated based on an identified data source type; executing a search on the data source using the structured query, the execution of the search resulting a result set; identifying a visualization type based on a type of data included within the result set; and generating a visualization based on the visualization type and the result set.

In another embodiment, a device is disclosed comprising a processor and a non-transitory memory storing computer-executable instructions therein that, when executed by the processor, cause the apparatus to perform the operations of receiving a natural language query; generating one or more interpretations based on the natural language query using one or more natural language processing procedures; generating a structured query based on the one or more interpretations, the structured query generated based on an identified data source type; executing a search on the data source using the structured query, the execution of the search resulting a result set; identifying a visualization type based on a type of data included within the result set; and generating a visualization based on the visualization type and the result set.

In another embodiment, a system is disclosed comprising a query analyzer comprising at least one server configured to receive a natural language query and generate one or more interpretations based on the natural language query using one or more natural language processing procedures; a query engine comprising at least one application server configured to generate a structured query based on the one or more interpretations, the structured query generated based on an identified data source type and execute a search on the data source using the structured query, the execution of the search resulting a result set; and a visualization engine comprising at least one application server configured to identify a visualization type based on a type of data included within the result set and generate a visualization based on the visualization type and the result set.

### BRIEF DESCRIPTION OF THE DRAWINGS

FIG. 1 is a block diagram illustrating a system for generating visualizations based on natural language queries according to some embodiments of the disclosure.

FIG. 2 is a flow diagram illustrating a method for generating visualizations based on natural language queries according to some embodiments of the disclosure.

FIG. 3A is a flow diagram illustrating a lexical analysis procedure applied to a natural language query according to some embodiments of the disclosure.

FIG. 3B is a flow diagram illustrating a syntactic analysis procedure applied to a natural language query according to some embodiments of the disclosure.

FIG. 3C is a flow diagram illustrating a semantic analysis procedure applied to a natural language query according to some embodiments of the disclosure.

FIG. 4A is a flow diagram illustrating a method for expanding a query according to some embodiments of the disclosure.

FIG. 4B is a flow diagram illustrating a method for translating and executing a query according to some embodiments of the disclosure.

FIG. 5 is a flow diagram illustrating a method for automatically selecting a visualization for a data set according to some embodiments of the disclosure.

FIG. 6 is a hardware diagram illustrating a device for generating visualizations based on natural language queries according to some embodiments of the disclosure.

### DETAILED DESCRIPTION

The disclosed embodiments will be described more fully hereinafter with reference to the accompanying drawings, which form a part hereof, and which show, by way of illustration, certain example embodiments.

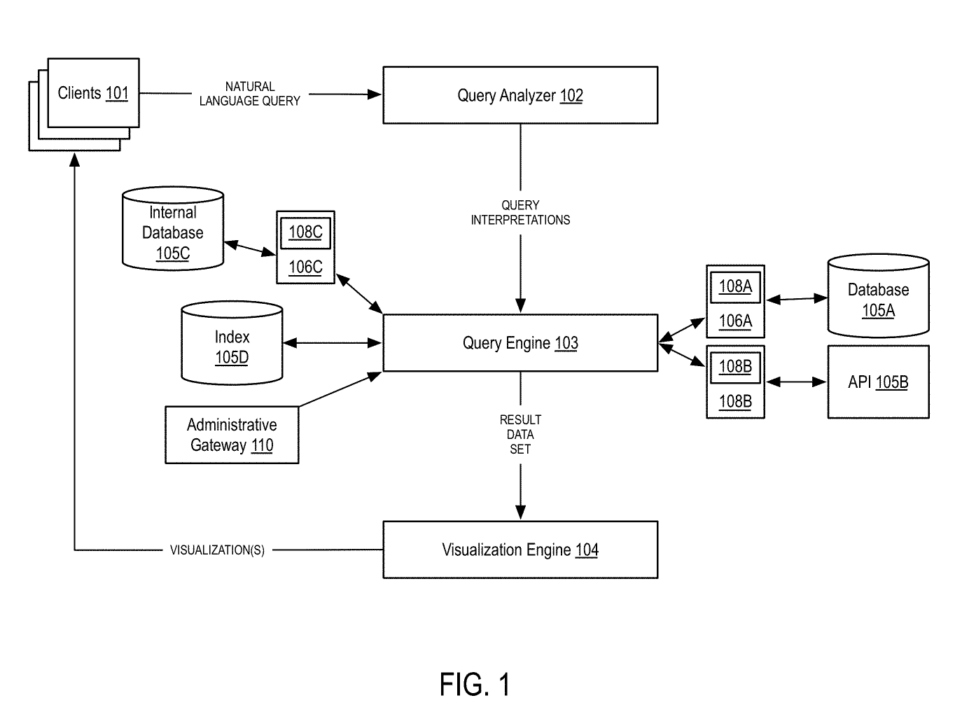

FIG. 1 is a block diagram illustrating a system for generating visualizations based on natural language queries according to some embodiments of the disclosure.

The system includes one or more client devices (101). In one embodiment, a client device refers to an end user computing device (e.g., a laptop, desktop, mobile phone, tablet, or other networked computer device). Alternative, a given client device may comprise a server or other non-consumer computing device. Generally, each client device includes a communications interface allowing for communication between query analyzer (102) and visualization engine (104).

If a client device comprises an end user device, the client device may be equipped with a browser or other network-enabled application allowing for the input of information by the operator of the client device. Alternatively, or in conjunction with the foregoing, the client device may include various applications capable of issuing network requests and receiving, processing, and (optionally) displaying data. As an example, client devices (101) may include a plurality of laptop or mobile phones operated by end users and a plurality of servers configured to receive requests from other client devices and forward such requests to query analyzer (102).

The system further includes query analyzer (102), query engine (103), and visualization engine (104). While illustrated as separate components, query analyzer (102), query engine (103), and visualization engine (104) may be co-located on a single device (e.g., a server device). Alternatively, some or all of query analyzer (102), query engine (103), and visualization engine (104) may be distributed across various computing devices and, in some instances, geographic areas. Alternatively, or in conjunction with the foregoing, query analyzer (102), query engine (103), and visualization engine (104) may also be replicated in various permutations in order to provide reliable uptime for each of the components. For example, query analyzer (102) may be replicated in various geographic regions in order to receive queries faster. Conversely, query engine (103) and visualization engine (104) may comprise single devices or a smaller replicated set of devices located in a centralized region. Certainly, other permutations or arrangements of replicated devices may exist and the disclosure is not intended to be limited to a specific configuration of devices. For the sake of clarity, the system is described wherein query analyzer (102), query engine (103), and visualization engine (104) each comprise a single device or, alternatively, are implemented on a single device.

In one embodiment, query analyzer (102) is configured to receive natural language queries from one or more clients (101). As such, query analyzer (102) may comprise a web server and one or more application servers. In one embodiment, query analyzer (102) comprises one or more webservers (with an option load balancer if multiple web servers are used) configured to receive HTTP requests or other network requests from client devices (101). In one embodiment, a load balancer may be communicatively coupled to a plurality of application servers to manage the flow of incoming requests. In one embodiment, each application server may comprise a physical server or, alternatively, a virtual server or serverless computing instance. In one embodiment, the number of application servers may be determined according to the processing needs of the systems. Similarly, in some embodiments, the number of application servers may be determined dynamically based on the number of requests submitted by clients. In this manner, the system may scale up or scale down the number of application servers according to the needs of the system (specifically, the demand on the system).

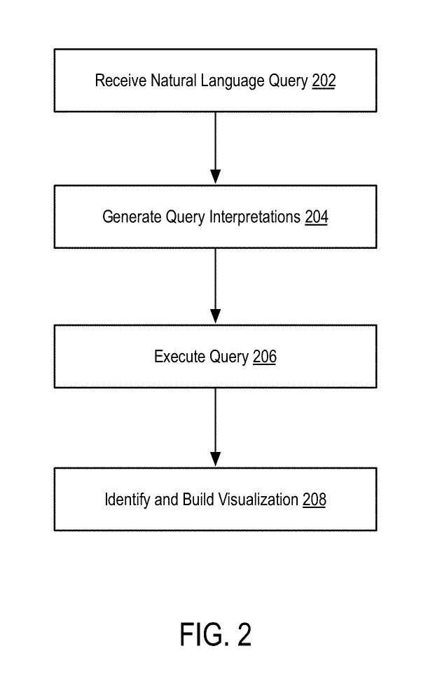

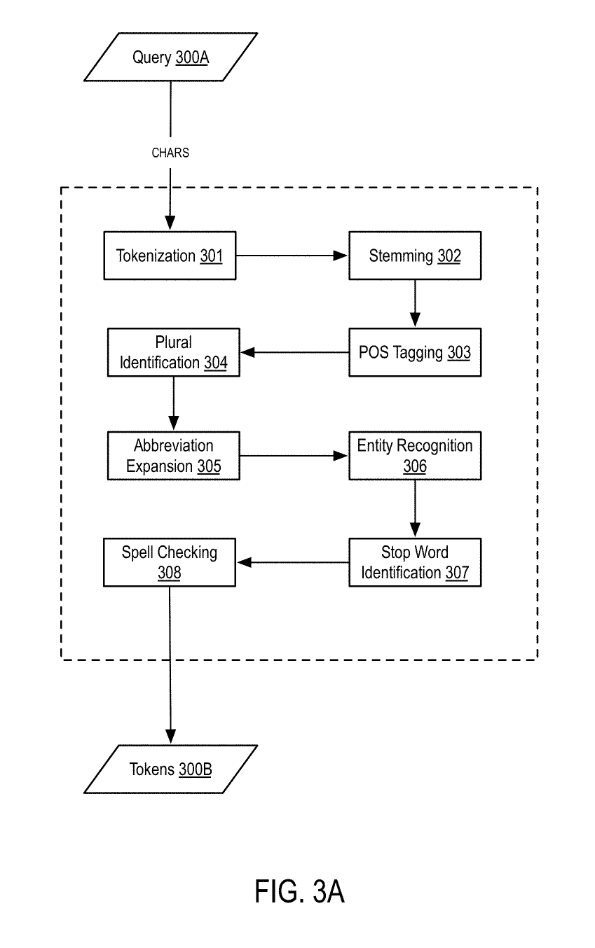

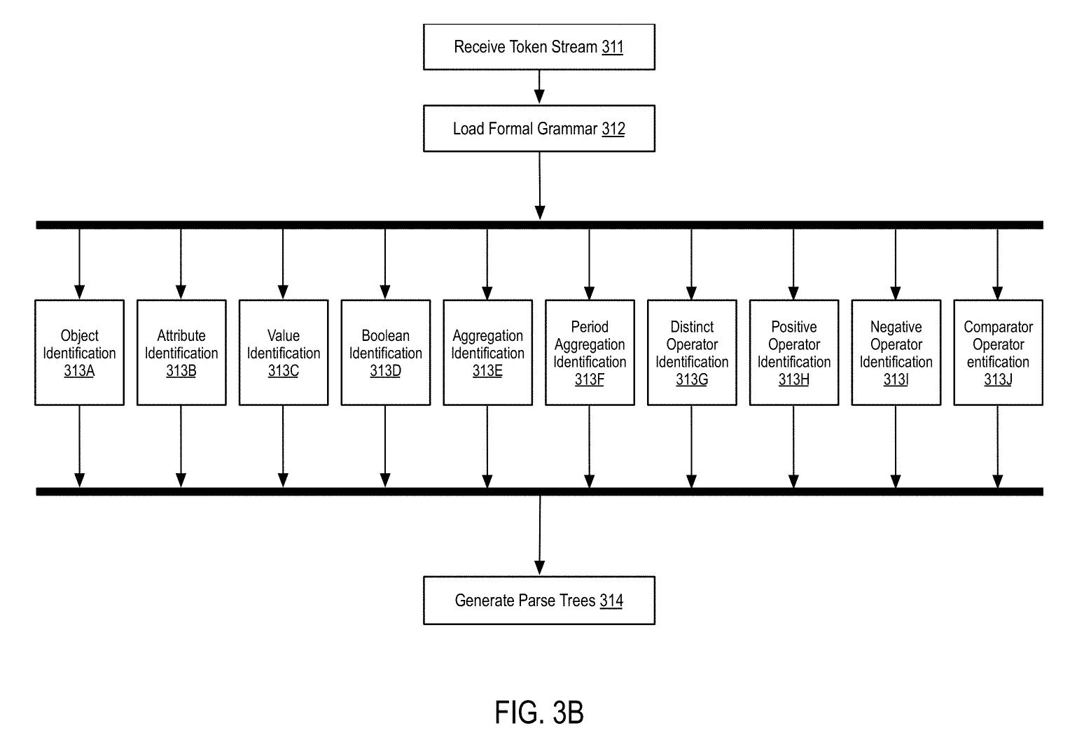

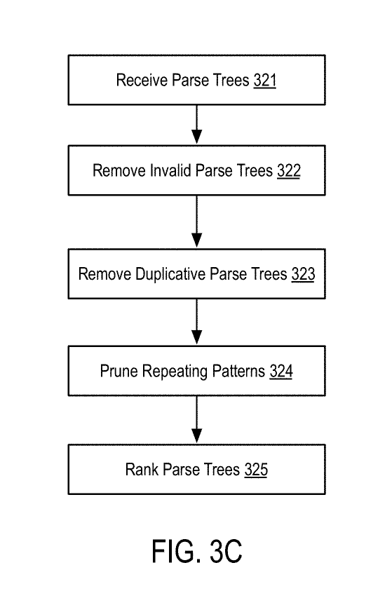

Operation of the query analyzer (102) is described more fully in connection with FIGS. 2 and 3A-3C, the disclosure of which is incorporated herein by reference in its entirety. Generally, however, query analyzer (102) is configured to receive a search query in a natural language (e.g., a plain text question) and generate one or more query interpretations. Query analyzer (102) may additionally request that the user of the client device redefine any interpretations. Ultimately, query analyzer (102) transmits the query interpretations to query engine (103). As discussed previously, query analyzer (102) may transmit the interpretations over a network to query engine (103) or, alternatively, may transmit the interpretations via a system bus of a single computing device depending on the specific implementation.

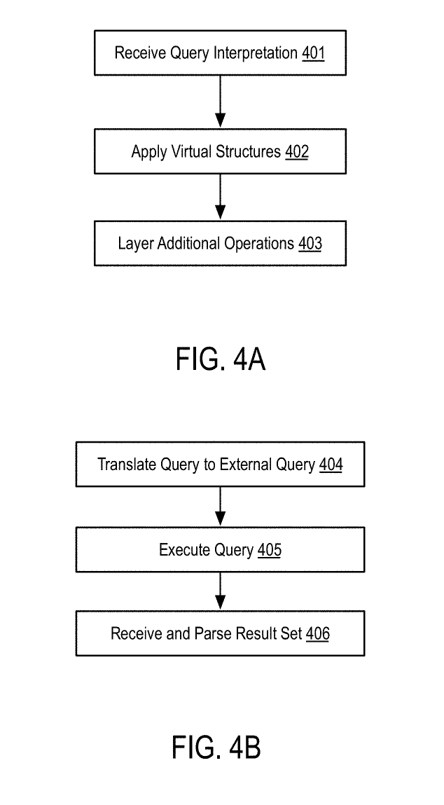

The system additionally includes a query engine (103). In one embodiment, the query engine is configured to receive the query interpretations (or, parse trees) from query analyzer (102) and generate an internal query representation. In one embodiment, the query engine (103) may expand a query interpretation, apply virtual structures to the query interpretation, and layer additional operations to the query interpretation. Details of these operations are provided in connection with FIG. 4A, the disclosure of which is incorporated herein by reference in its entirety.

Query engine (103) is also connected to database (105A), API (105B), and internal database (105C) via data connectors (106A, 106B, and 106C). In one embodiment, query engine (103) transmits internal query representations to data connectors (106A, 106B, and 106C). In turn, the data connectors (106A, 106B, and 106C) convert the internal query representation to an external query request, as described in more detail in connection with FIGS. 4A-4C. Data connectors (106A, 106B, and 106C) generate external queries using data schemas (108A, 108B, 108C). In one embodiment, data schemas (108A, 108B, 108C) comprise XML representations that define the parameters required to connect to a data source as well as the specific data schema to use to query tables, columns, relations, etc. Alternatively, or in conjunction with the foregoing, the schema may include semantic information or labels used by the system during the analysis of the query.

As illustrated in FIG. 1, a plurality of data sources may be connected to query engine (103) via data connectors (106A, 106B, and 106C). As illustrated, database (105A) may comprise a remote database connected, via a network, to query engine (103). In one embodiment, database (105A) may provide external, remote access to query engine (103) via a network or socket connection. In turn, connector (106A) may be able to issue queries (e.g., SQL queries) to the database (105A) after generating the external query forms. Internal database (105C) may comprise a similar structure but may be internal to the network operating the system. In this way, the system may have fuller access to the underlying data and may have more options in querying the data. API (105B) may comprise an HTTP server that responds to requests (e.g., REST, SOAP, RPC, etc.) over a network at defined endpoints. API (105B) may utilize an internal database (not illustrated) inaccessible to the system other than through the endpoints. While illustrated as three data sources, there is no limit to the number or type of data sources that the system may access.

In one embodiment, internal database (105C) may comprise a replication of a remote database (e.g., 105A). In this embodiment, the system imports data from the remote database and stores the data locally in internal database (105C), thus avoiding network requests to the remote data. In some embodiments, internal database (105C) may be continuously updated based on crawls of the remote database. In other embodiments, internal database (105C) may be kept in sync with a remote database using a synchronization protocol.

The system additionally includes an index (105D). In one embodiment, index (105D) indexes textual data stored by remote or internal data sources. In one embodiment, the system may continuously crawl external data in order to populate the index (105D). In one embodiment, index (105D) comprises an inverted index with a correspondence between terms and their columns, tables, or other organizational structures utilized by the data sources (e.g., documents in a document-oriented database, flat files, etc.). In some embodiments, only text data is indexed in index (105D) while numerical or date information is not indexed.

In some embodiments, index (105D) may only be used for data sources that do not employ indexing. For example, many databases (e.g., 105A, 105C) provide indexing capabilities as part of regular operations. In this case, the system may not index data stored by such databases, thus minimizing the storage requirements of index (105D). Similarly, an HTTP endpoint may only provide for limited discoverability of all data and indexing the entire underlying data may be infeasible (e.g., if querying, for example, a FACEBOOK endpoint). Thus, in many cases, the index (105D) may only store a portion of data with a known lack of indexing. For example, if a data source comprises a file transfer protocol (FTP) location with static, text documents, the system may index all documents at the FTP site.

The system further includes an administrative gateway (110). In one embodiment, administrative gateway (110) may provide access to manage the system. In one embodiment, administrative gateway (110) allows for the creation of data schemas (108A-108C). In another embodiment, administrative gateway (110) allows for the creation of new formal grammars and updates to existing formal grammars (discussed more fully in connection with FIG. 4B).

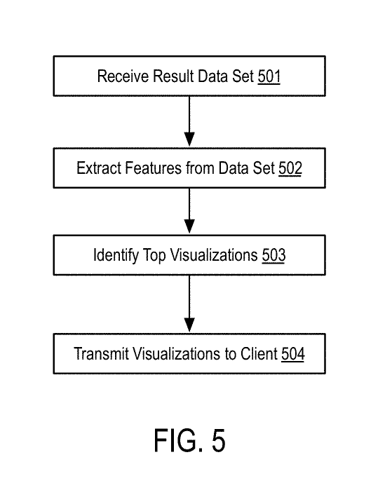

The system further includes a visualization engine (104). In one embodiment, the visualization engine (104) receives a result data set from query engine (103) and generates one or more visualizations for the data. In one embodiment, the visualization engine (104) extracts features from the result data set and identifies candidate visualization capabilities for the underlying data. The method may then rank the visualization capabilities using a Case Based Reasoning approach and populate the visualizations with the result data set. Finally, visualization engine (104) transmits the resulting visualizations to the user. Operations of the visualization engine (104) are described in more detail in FIG. 5, the disclosure of which is incorporated herein by reference in its entirety.

FIG. 2 is a flow diagram illustrating a method for generating visualizations based on natural language queries according to some embodiments of the disclosure.

In step 202, the method receives a natural language query.

In one embodiment, a natural language query may be received via a search form, via an API, or generally via any mechanism capable of transmitting data from a searching entity (e.g., an end user, application, etc.) over a network. For example, the method may be employed by a search engine that provides a search interface allowing users to express natural language queries via a textbox embedded within a webpage. Alternatively, the method may be employed as an API endpoint and may receive natural language queries via an HTTP request that includes, as a payload of the HTTP request, the natural language query.

As used herein, a natural language query refers to a text string that represents a human-understandable information goal. For example, a natural language query may comprise “show me the amount of each product sold in Portugal this year on a monthly basis.” Various other types of queries may be submitted as described in the numerous examples presented herein. Generally, however, the natural language query does not require a structured form (e.g., a list of form options combined into a data structure) but rather is a plaintext string. In some embodiments, the natural language query may be generated based on an image or based on audio (e.g., via a voice input). In some embodiments, a natural language query may comprise an audio file uploaded by a user and converted into a text string. Alternatively, the audio may be converted by the client and uploaded as a text string (via voice-to-text recognition).

In step 204, the method translates the natural language query into a plurality of query interpretations or parse trees. Query interpretations and parse trees are referred to herein interchangeably based on the use of the structure. Specific embodiments of methods for translating a natural language query are described in connection with subsequent figures (principally, FIGS. 3A-3C) and the disclosure of these figures is incorporated herein by reference in its entirety.

In some embodiments, step 204 may include various sub-processes used to generate a structured query. As described in more detail herein, in step 204, the method may employ lexical, syntactic, and semantic processing procedures to convert the natural language query into a set of query interpretations. Details of these specific operations are described more fully herein and are incorporated herein by reference in their entirety. During a lexical phase, the method may apply tokenization, stemming, spell-checking, and other procedures to generate a sequence of tokens representing the underlying query. During a syntactic phase, the method may employ object identification, attribute identification, and other procedures to generate a parse tree (e.g., using a chart parser) representing the sequence of tokens. Finally, in the semantic phase, the method may perform various operations to analyze and parse the parse trees including removing invalid and duplicate interpretations.

In some embodiments, the method may generate multiple query interpretations and rank these interpretations prior to proceeding to step 206. In one embodiment, the method may select the top-ranking interpretation or may, alternatively, or in conjunction with the foregoing, allow the user submitting the natural language query to select the best interpretation. In some embodiments, the ranking of parse trees may be refined based on domain-specific information or based on user histories.

In step 206, the method executes a search using a structured query generated based on the query interpretations.

In one embodiment, step 206 may include multiple phases as described in more detail in connection with subsequent figures. In one embodiment, step 206 may comprise expanding the query interpretations received from step 204. In one embodiment, expanding a query interpretation comprises converting potentially conceptual concepts into lower level components. Details of query expansion are described more fully in connection with FIG. 4A, the details of which are incorporated herein by reference in their entirety.

In one embodiment, step 206 may additionally include a query translation procedure. In this embodiment, the method translates the expanded query into an internal query representation and, subsequently, into an external query representation. For example, the method may define and utilize a domain-specific query language that is data-source agnostic. Specifics of the internal query language may vary depending on the needs of the internal system and are not intended to be limiting. As part of translating the internal query representation, the method first determines which data sources are required to fulfill the query.

As described above, the method may access a variety of data sources and thus may translate the internal query into multiple external queries.

In one embodiment, a structured query may comprise a database command (e.g., an SQL statement). In this embodiment, the structured query may comprise a single statement (e.g., a SELECT statement) or may comprise a series of SQL statements (e.g., a transaction).

In another embodiment, the structured query may comprise an HTTP request to an API or other HTTP endpoint. In this embodiment, the structured query may comprise a series of key/value pairs, a JSON object, or other payload supported by HTTP or similar protocols.

Continuing the previous example query (“show me the amount of each product sold in Portugal this year on a monthly basis”), a database statement may generated of the form “SELECT product_name, quantity FROM sales WHERE sale_date IS 2017 GROUP BY month.” Notably, the database statement is illustrated as a pseudocode statement and may differ depending on the type of database used, the type of database being of any relational database.

Alternatively, the structured query may be generated as an HTTP GET request of the form “https://endpoint/sales?year=2017&group_by=monthly&fields=product_name,quantity.” As with the aforementioned database statement, the specific of the HTTP request may be dependent on the underlying API endpoint (as described herein) and is not intended to be limiting.

While the aforementioned example describes a one-to-one mapping between a natural language query and a structured query, in other embodiments, the method may generate multiple structured queries for a single natural language query. In this embodiment, the method may rank the generated structured queries and return the highest ranking structured query. In some embodiments, the method may allow the user to select the desired structured query. Each of these embodiments is described in more detail herein.

Finally, in step 206, the method may execute the query. In one embodiment, the method may identify a data source and an associated data schema representing the data source. In one embodiment, this schema comprises an XML (eXtensible Markup Language) document describing the data source. The XML schema may include parameters defining the data source such as table, column, and relation names (for a relational data source). Alternatively, or in conjunction with the foregoing, the schema may include semantic information or labels used by the system during the analysis of the query. In one embodiment, the method may transmit the external query to a data connector which maps to the data source and handles the network requests or internal requests required to execute the query.

In step 208, the method identifies and builds a visualization based on the results of search executed in step 206.

In one embodiment, in step 208, the method receives the data from the data source via an associated data connector. The method then analyzes the returned data to determine which visualization can be built on top of the given data. Then, the method selects the best visualization and parameterizes the visualization with the result set returned from the data source. The method may then transmit the resulting visualization to a client device for display.

In one embodiment, step 208 includes both an analysis and selection subroutine as described more fully in connection with FIG. 5. Generally, the analysis subroutine extracts a set of features from the returned data and applies one or more rules to determine one or more appropriate visualizations (referred to as visualization capabilities).

After identifying the visualization capabilities, the method may select the best visualization using a Case-Based Reasoning (“CBR”) approach. Specifically, the method may record successful visualization selections applied in the past. A “case” in the context of the CBR approach refers to a problem specification and solution. The problem specification contains information about the data to which the visualization was previously applied (e.g. the label of each column, the data type of each column, statistical information about the data of each column, etc.). The solution contains the information needed to build the visualization (e.g. the chart type, the axes to be used, the series to be used, etc.).

In one embodiment, the visualization selection process corresponds to the CBR retrieval phase. That is, the method utilizes a new set of data (the data returned from the data source) that must be visualized (the problem) and the selection of the best visualization possible for that data (the solution). Using the problem specification, the method selects a case from the case base that matches the current problem using a similarity function. In one embodiment, the similarity function is a weighted difference between the features of the problem and the features of the case. When a case is found, the solution of that case is adapted to solve the current problem. This means that if there exists a similar problem, or similar data, the method can use the same solution, or visualization, that was successfully used in the past.

The visualization selection process can also be personalized and learn over time. In one embodiment, this is possible because the method utilizes a CBR approach and can maintain a different case base for each user. That way, when the users select a specific visualization for the data, that action will trigger the creation of a new case in their individual case base. The cases that are created for each user will extend their case base and will be used in the future when selecting a visualization for a query of that specific user.

Finally, in step 208, the method may return the visualization to the user that issued the query. In one embodiment, the visualization may be returned as functionality within a webpage (e.g., implemented as JavaScript code, optionally, with graphics and other display elements for rendering the visualization). Alternatively, or in conjunction with the foregoing, the return visualization may simply comprise the data points for the visualization which may be utilized by a client-side rendering application (e.g., Chart.JS) or similar application. While described primarily in the context of webpages, the returned visualization is not limited strictly thereto. For example, the return visualization may be embedded within any application that supports the rendering of graphic content. For example, a word processing application may be configured with an “add-in” capable of issuing the natural language query and generating visualizations within the word processing application itself.

FIG. 3A is a flow diagram illustrating a lexical analysis procedure applied to a natural language query according to some embodiments of the disclosure.

As illustrated in FIG. 3A, the method takes, as an input, a natural language query 300A and returns, as an output, a series or stream of tokens 300B. In order to translate the query 300A into tokens 300B, the method employs one or more natural language processes and, specifically, one or more lexical parsing algorithms (301-308). In the illustrated embodiment, the tokens 300B comprise a sequence of tokens with assigned meanings derived during steps 301-308. While illustrated as a sequential sequence of steps, the disclosed method is not intended to be limited to the exact sequence illustrated. First, steps 301-308 may be re-ordered as needed. For example, tokenization may be performed first and steps 302-308 may be performed on individual tokens. Alternatively, the method may use string-based versions of the functions described in steps 302-308 for some or all of the steps prior to tokenization (e.g., by removing stop words, step 307, before tokenizing). Specific arrangements may be configured based on the needs of the production system. Second, some of steps 301-308 may be performed in parallel. For example, steps 303 and 304 may be executed in parallel. Notably, any step may be performed in parallel provided that the step does depend on another step performed in parallel.

In step 301, the method tokenizes the query.

In one embodiment, tokenization of a query comprises splitting a string of characters into a set of pieces referred to as tokens. In one embodiment, the method in step 301 splits a string of characters based on white space or punctuation. Thus, a simplistic string “show me all phones, tablets, and laptops sold in 2017” may generate the tokens “show”, “me”, “all”, “phones”, “tablets”, “laptops”, “sold”, “in”, and “2017”, eschewing spaces and commas. In one embodiment, step 301 may additionally tag tokens with a datatype when possible. For example, step 301 may tag all numbers, time, and currency tokens as part of the tokenization process. Thus, the method may tag the token “2017” as a number or, optionally, as a date, time, or datetime.

In step 302, the method performs a stemming operation on the tokens.

In one embodiment, the stemming operation condenses a token into its root word. In some embodiments, stemming may only be performed on non-numeric or non-date/time tokens. For example, a token sequence may include the words “stemming”, “sells,” and “pushed.” Each of these may be stemmed to the root words, “stem,” “sell,” and “push.” By stemming the tokens, each token removes inflection forms of the word and normalizes each token to a base form to allow for improved processing in later stages (and overall). In some embodiments, the method may utilize a set of rules for removing suffixes or prefixes (e.g., removing “-ing” from strings and adding characters, as necessary, to form a base word). Alternatively, the method may utilize a dictionary of stemming definitions.

In step 303, the method performs a part of speech (POS) tagging operation on the tokens.

In this step, the method tags each token according to a part of speech in English, or in a local language (e.g., Portuguese). Thus, the method may assign labels of, for example, “noun,” “verb,” “adjective, “adverb,” etc., to each token. The complexity of the parts of speech may be defined by a system administrator. For example, in a basic implementation, the method may only distinguish between nouns, verbs, and “other” parts of speech. In other systems, the method may employ more complex or exotic forms of speech depending on the domain-specific needs of the system (e.g., the business area of the underlying data or the specific language utilized for the natural language query). In one embodiment, the method may utilize a dictionary of terms and their part of speech association. In alternative embodiments, the method may utilize hidden Markov models or other machine-learning based POS tagging methods.

In step 304, the method performs a plural identification operation on the tokens.

In this step, the method tags each token as either singular or plural. In one embodiment, plural identification may be made by detecting the presence of an “s” or “es” at the end of a token (for English tokens). Alternatively, or in conjunction with the foregoing, the method may utilize more sophisticated methods for identifying plural words (including identifying irregular pluralization). In one embodiment, the method may further utilize a lemmatization procedure for performing the plural identification step.

In step 305, the method performs an abbreviation expansion operation on the tokens.

In this step, the method converts any tokens representing known abbreviations. For example, the token “USA” may be converted to “United States of America” or “America.” In one embodiment, the method may use a dictionary of abbreviations. In one embodiment, this dictionary may be a global dictionary while in other embodiments it may be a global dictionary supplemented (or overridden) with domain-specific abbreviations. For example, the abbreviation “RCE” may be set globally as “remote code execution” while in a patent-specific environment this abbreviation may be overridden as “request for continued examination.”

In step 306, the method performs an entity recognition operation on the tokens.

In one embodiment, the method may utilize a list of known entity expressions to tag tokens matching these entities. In one embodiment, a system administrator may define a set of entities and related tokens. Specifically, the administrator may define a group of related terms and associate these terms with a single entity. For example, if the method was employed by a football club, the administrator may associate the tokens “striker,” “keeper”, or “trequartista” as associated with the entity “player” or “position.” Similarly, the administrator in the preceding example may explicitly associated special words with entities (e.g., “ST”, “CB”, “GK”, as “player”).

In step 307, the method performs a stop word identification operation on the tokens.

In one embodiment, the method removes all tokens corresponding to stop words. In a first embodiment, the method may utilize a dictionary of stop words (e.g., “a”, “an”, “the”, “on”, etc.). Alternatively, or in conjunction with the foregoing, the method may allow for user-defined stop words. In one embodiment, the method removes tokens corresponding to stop words from the token stream 300B. In alternative embodiments, the method tags tokens as stop words yet retains the tokens in the token set 300B.

In step 308, the method performs a spell-checking operation on the tokens.

In one embodiment, each token is analyzed to ensure no misspellings occur within the token. Although illustrated as a final step, step 308 may alternatively be performed earlier in the pipeline of operations illustrated in FIG. 3A.

As described above, the results of steps 301-308 are a series of tokens with ascribed meanings gleaned from some or all of the processing steps 301-308. In each step, the token may be supplemented with details regarding its contents (e.g., it may be tagged with the results of each processing stage). As will be described in connection with the next figure, these tokens are transmitted (either internally or via a network) to a syntactic processing system for further analysis.

FIG. 3B is a flow diagram illustrating a syntactic analysis procedure applied to a natural language query according to some embodiments of the disclosure.

In step 311, the method receives a token stream.

As discussed above, the token stream comprises a series of tokens with ascribed meanings generated by a lexical parsing procedure (e.g., as described in FIG. 3A).

In step 312, the method loads a formal grammar for parsing the token stream.

In one embodiment, a formal grammar comprises a set of production rules used for assigning interpretations to strings or sequences of tokens. In one embodiment, the formal grammar may comprise a context-free grammar or, more specifically, an ambiguous grammar. The use of an ambiguous grammar results in multiple parse trees as compared with other grammars that result in a single parse tree. In one embodiment, the method may utilize a single formal grammar. In alternative embodiments, the method may identify the formal grammar based on the domain in which the method is operating. For example, the method may utilize a formal, ambiguous, legal grammar for handling legal queries. Alternatively, the method may utilize a formal, ambiguous, programming grammar if handing queries regarding programming topics or source code. As another example, the method may utilize a formal, ambiguous, product grammar when handling inquiries regarding consumer products etc. Specific rules are described in connection with steps 313A-313J.

In steps 313A-313J, various rules in a formal grammar are applied by a parser as described in more detail herein. Details regarding the use of a parser are given in more detail in connection with step 314 and are not included herein.

In step 313A, the method identifies objects, tables, or references defined in the token stream that are define in a schema definition associated with a data source. As described above, a schema definition may include the identification of object names, table names, relations, or other identifying characteristics of the data source. In this step, the method identifies tokens that correspond to those schema definition items and identifies those tokens that satisfy a pattern representing the identified objects. For example, the token “products” may correspond to a table “products” in a data schema.

In step 313B, the method identifies attributes present within the token stream. Similar to step 313A, a data schema may also store column names, attributes names, or references associated with the underlying data source. For example, the token stream may include a token sequence “color is black”, thus including the token “color” which may correspond to a column name of a database table. Thus, the method identifies the token as corresponding to an attribute.

In step 313C, the method identifies textual values that exist in the data and are found in the text associated with a data source. In this instance, the textual values may correspond to actual values stored within a database. As described above, the method may utilize an index of all textual values for a data source to identify corresponding textual values. Thus, continuing the example of “color is black”, the “color” field of a database may be indexed, thus indexing each color stored by rows within the database table. In one embodiment, the method may identify textual values using an index of text values occurring within a data source, as described above.

In step 313D, the method performs Boolean identification. In this instance, Boolean identification refers to the identification of Boolean operators or their language equivalents. For example, the method may identify tokens representing “or”, “equals,” “less than,” “less than or equals,” “greater than,” “greater than or equals,” and “between.” For example, a portion of a query may include the phrase “products with a price greater than 1000” which may be tokenized into “products price greater than 1000.” In steps 313A, “products” may be identified as an object or table name, “price” may be identified as an attribute, “1000” may be identified as a number (via the tagging operations discussed previously) and “greater than” may be identified as a Boolean operator.

An example grammar portion implementing these rules may be defined as follows (nothing that the below grammar is a pseudo-grammar and not intended to be limiting):
1. ATTRIBUTE_QUERY=OBJECT ATTRIBUTE BOOLEAN VALUE
2. OBJECT=[product|user|order| . . . ]
3. ATTRIBUTE=[price|name| . . . ]
4. BOOLEAN=[greater than|less than|or| . . . ]
5. VALUE=[INTEGER|FLOAT|TEXT| . . . ]
6. INTEGER=[1, 2, 3 . . . ]

Notably, line 2 corresponds to an object (or table) rule (step 313A), line 3 corresponds to an attribute rule (step 313B), line 4 refers to a Boolean rule (step 313D), and lines 4 and 5 define value rules (step 313C), specifically limited to integer values. As discussed previously, line 5 may also include textual values corresponding to indexed values of a database (e.g., VALUE=[ . . . COLOR . . . ]; COLOR=[red|black|brown| . . . ]). In one embodiment, line 1 describes a higher-level rule (not illustrated) that may be built with the rules discussed in steps 313A-313J.

In step 313E, the method performs aggregation identification. In one embodiment, aggregation identification comprises identifying aggregating operators that are applied to a set of aggregated values of a column. For example, an aggregation operator may correspond to the terms “count”, “max”, “min”, “average”, “deviation”, “variance”, “mode”, “median”, and “sum.” For example, the query portion “average price by product category” includes the aggregation operator “average.” Continuing the previous example grammar, rules of
7. AGGREGATION=AGGREGATION_OPERATOR+ATTRIBUTE_QUERY
8. AGGREGATION_OPERATOR=[count|max|min| . . . ]
   may be supplied to perform step 313E.

In step 313F, the method performs period aggregation operation identification. In one embodiment, period aggregation operators comprise a set of operators that are used to aggregate, for example, database rows by period of time, including “by minute of hour”, “by hour of day”, “by day of week”, “by day”, “by week”, “by month”, “by quarter”, “by year.” For example, the query portion “sum sales by month” includes the period aggregation operator “by month.” Continuing the previous example grammar, rules of
9. PERIOD_AGGREGATION=[sum|average| . . . ] ATTRIBUTE PERIOD_AGGREGATION_OPERATOR
10. PERIOD_AGGREGATION_OPERATOR=by [month|year|quarter . . . ]
   may be supplied to perform step 313F.

In step 313G, the method performs a distinct operator operation. In one embodiment, a distinct operator operation may include a rule detecting that a token comprises a “distinct” keyword (or equivalent keyword).

In step 313H, the method performs a positive operator operation. In one embodiment, a positive operator operation may comprise detecting tokens that indicate that a given attribute should be positive. In one embodiment, a positive value comprises a true value. In some embodiments, a positive value comprises a non-null value. For example, the phrase “sum sales that are online” includes the positive operation “are online” for a column, “sales.”

In step 3131, the method performs a negative operator operation. In one embodiment, a negative operator operation may comprise detecting tokens that indicate that a given attribute should be negative. In one embodiment, a negative value comprises a false value. In some embodiments, a negative value comprises a null value. For example, the phrase “sum sales that are not online” includes the negative operation “are not online” for a column, “sales.”

In step 313J, the method performs a comparator operator identification operation. In one embodiment, a comparator operator comprises a token, or set of tokens, that defines a comparison. For example, the token “vs” (or “versus”) may be used to indicate two queries should be compared.

In step 314, the method generates parse trees after applying the rules in steps 313A-313J.

As mentioned above, the method may utilize a chart parser to apply the rules described in steps 313A-313J. In one embodiment, the chart parser is configured to utilize partial hypothesized results in order to reduce backtracking and inefficient processing caused by backtracking parsers.

In one embodiment, the chart parser loads the formal grammar, applies the rules defined in the formal grammar and generates a plurality of parse trees. Notably, the method, in step 314, can generate one parse tree or multiple parse trees for a given natural language query. Notably, multiple parse trees may exist due to the ambiguity inherent in natural language as well as the specifics of the underlying data source. For example, object, attribute, and value identifiers may overlap, resulting in multiple variations in parse trees (e.g., one interpreting a token as teach type of identity, and variations stemming therefrom). Consider as an example, a database with a table “cars,” and an attribute of a garage which is equally, “cars” (assuming no normalization). To complicate matters, a “users” table may have an attribute “interests” which also may include the text value “cars.” While many of the resulting parse trees may be illogical, they may nonetheless be a proper parse tree of a given ambiguous natural language query. For example, the token “cars” cannot be definitively resolved to the table, attribute, or value. Thus, the parse trees must further be processed semantically to identify a smaller number of potentially relevant parse trees as discussed herein.

FIG. 3C is a flow diagram illustrating a semantic analysis procedure applied to a natural language query according to some embodiments of the disclosure.

In step 321, the method receives parse trees. In one embodiment, the parse trees correspond to the parse tress generated in FIG. 3B.

In step 322, the method removes invalid parse trees.

In one embodiment, removing invalid parse trees comprises analyzing each of the parse trees to determine if the resulting tree defines a valid interpretation. That is, determining if the resulting tree describes a well-formed request for information. For example, parse trees that reference two or more objects that have no relation between them (e.g. the query “count clients by store” is not valid if there is no actual relation between these objects in an associated schema), or interpretations where a filter is not compatible with the data type of the column to which it is being applied (e.g. “clients with name>100”).

In step 323, the method removes duplicative parse trees.

In one embodiment, the resulting parse trees received in step 321 may include duplicative trees. Specifically, while the actual nodes of the parse tree may be different, the represented interpretation reflects the same information goal or will result in the same retrieved data. For example, due to the ambiguity in parsing, a first parse tree may result in a node that indicates a condition “status=online” and a second parse tree my result in a node that indicates a condition “status !=offline.” Assuming “status” is a Boolean variable and is not null, both conditions are equal. Further assuming that the remainder of the parse trees are equivalent or equal, the method determines that the two parse trees, while structurally different, result in the same conditions and same information returned. Thus, in step 323, the method removes these duplicate interpretations from the final set of valid parse trees.

In step 324, the method prunes repeating patterns in the remaining parse trees. In some embodiments, the parsing process (FIGS. 3A and 3B) may generate repeated patterns that can be removed. There are also some patterns that can be combined to reduce complexity and improve performance. Additionally, the method may remove, within a given parse tree, nodes that result in duplicative conditions. For example, a parse tree may include “status=online” and “status !=offline” which represent duplicative conditions. Thus, the method may remove one of the duplicative conditions to prune the parse tree further.

In step 325, the method ranks the parse trees.

In one embodiment, the method ranks parse tree according to their relevance to the initial natural language query. In this embodiment, the method may further select the top-ranking parse tree and utilize that parse tree as the proper interpretation of the natural language query.

In one embodiment, the relevance of each parse tree is computed based on a set of features, which are combined using a weighted sum model. The weights for each feature are optimized using a genetic algorithm approach. A genetic algorithm is a method to solve optimization problems. In one embodiment, the process starts with a randomly generated population of candidate solutions, referred to as “individuals.” In this case, each candidate solution comprises a set of weights that will be used in the weighted sum model to compute the relevance of the candidate parse trees. Then, the population of candidate solutions goes through an iterative process where each iteration is called a generation. In each generation, the individuals are evaluated using a canonical dataset composed of questions and the ranked interpretations for those questions. The best candidates are picked for the next generation, while others are randomly changed, or mutated, or combined. The process may be stopped after a specified number of generations or when a satisfactory fitness level is reached. The system uses a default set of weights that were optimized using a canonical, standard dataset, but is can be optimized for specific domains by running the genetic algorithm again using domain-specific datasets.

In one embodiment, the best-ranked parse tree is selected to generate an answer for the user. In some embodiment, the method may present the user with alternative parse trees and allow the user to choose a different one if the parse trees that is presented is not the desired one. In this embodiment, user selection of alternative parse trees is used to deal with the ambiguity that is commonly associated with a natural language query. The system is able to generate all possible parse trees for the given question, rank these parse trees according to previously learned model and select what is considered the best parse tree for that question. But in the end, the users are informed about the parse tree that is being presented and have the ability to change to a different parse tree according to their needs. In some embodiment, the parse trees may be formatted as quasi-natural language statements before presenting them to the user to enable a user to easily select a best parse tree.

FIG. 4A is a flow diagram illustrating a method for expanding a query according to some embodiments of the disclosure.

In step 401, the method receives a query interpretation. As used herein a query interpretation refers to a parse tree generated as the output of the processes described in connection with FIGS. 3A-3C.

In step 402, the method applies virtual structures to the query interpretation.

In one embodiment, a virtual structure comprises one or more processing rules used to convert a potentially higher-level conceptual query interpretation into a set of low-level query primitives used to represent the interpretation. In general, virtual structures may be defined by a system administrator or may generated programmatically by analyzing correlations between past interpretations and internal query representations.

In one embodiment, the virtual structures include a query alias structure. A query alias structure comprises a mapping of a defined term or phrase to an expanded query portion. For example, the token “active customers” may be expanded to a lower level query representation of all customers that have a purchase order within the last six months (as of the date of the query). Thus the query “sum the price of all products ordered by active customers” may be expanded to “sum the price of all products ordered by all customers having a purchase order within the last six months.” In general, any phrase that may be expanded into a lower level query may be utilized to expand the interpretation.

Alternatively, or in conjunction with the foregoing, the virtual structures may further include a virtual column structure. As used herein, a virtual column structure refers to a column that does not exist in the underlying data source schema and whose values are computed during runtime using a formula based on the values of other columns of the same table (e.g. one can add a column named “Credit Score” to the table “Account” that is computed based on the current balance value for each account).

Alternatively, or in conjunction with the foregoing, the virtual structures may further include a virtual table structure. As used herein, a virtual table is a table that does not exist in the underlying data source schema and whose rows are computed during runtime using a specific query (e.g. one can add a table named “Best Products” whose rows contain the data for products that have a sales amount greater that a specified value).

In step 403, the method layers additional operations on top of the expanded query interpretation.

In one embodiment, additional operations may comprise transformations on the return data set specified in the user query. In one embodiment, additional operations include pagination, search, navigation, and drill down operations (discussed below).

A pagination operation comprises a portion of the query interpretation that acts as a limit and offset of the resulting data set. In one embodiment, a pagination operation is separate from the natural language query. In this embodiment, the pagination operation may be supplied as an additional parameter forming the search. For instance, the pagination operation may comprise one or more operations supplied via user interface elements (e.g., dropdown menus, etc.) present on a search interface. Alternatively, or in conjunction with the foregoing, the pagination operation may also be derived automatically based on the device issuing the query. For example, the pagination option may be set to a higher number of results per page for laptop/desktop devices and a smaller number of results per page for mobile devices. In another embodiment, the pagination operation may be part of the natural language query. For example, a query may comprise “sum the price of all products for each active customer and show me the top 10 customers.” Here, the token “top 10 customers” acts as a pagination operation in that it acts as a limit to the resulting data set and includes an underlying pagination operation (e.g., via an SQL OFFSET statement). Thus, the method expands the query to explicitly recite a lower level interpretation of “top 10 customers” as applying a LIMIT to the customers return to ten and setting an OFFSET to zero (and, implicitly, setting an ORDER BY condition to the SUM operation per customer).

A search operation comprises a keyword search that further refines the returned data. In one embodiment, search operations may be applied after the returned data is transmitted to the end user. For example, a search operation may comprise a filtering operation allowing a user to perform a text search of a visualized data set that is currently displayed on a device. In this example, the filtering operation may be performed client-side after receiving the returned data. Alternatively, or in conjunction with the foregoing, the filter may also result in secondary queries that query an entire data set and update (e.g., via asynchronous requests) the view of the result set displayed on the device. In another embodiment, a search operation may be detected by detecting the presence of one or more search triggers such as “find” or “where” within a natural language query. For example, a query may comprise “find all comments posted for Phone X and find comments that mention defects.” Here, “find” indicates a search operation and “comments that mention defects” describes the attribute (discussed above) to perform a keyword search on, finally “defects” comprises the keyword to search.

A navigation operation comprises an operation that allows the user to retrieve one or more results by navigating through the columns that point to other related tables (e.g. when navigating the “Orders” table, the user may click on the “Products” column to see all the products associated to a specific order).

Finally, a drill down operation comprises an operation that allows the user to drill down data by clicking on aggregated values that exist in the query results (e.g. clicking the summed value of the “Amount” of orders, when orders are being aggregated by country, to see the individual amount of the orders that contributed to the sum).

After processing the query interpretation in steps 401-403, the method generates a finalized internal query representation that is ready for translation and execution, discussed below.

FIG. 4B is a flow diagram illustrating a method for translating and executing a query according to some embodiments of the disclosure.

In step 404, the method translates the expanded query into an external query.

As discussed above, the expanded query may be stored in an internal representation. In one embodiment, this may comprise a generic query language that is agnostic from a query language (or process) required by a data source (e.g., SQL, SOAP, REST, etc.). In this manner, queries to disparate data sources may be processed (as described previously) in a uniform manner and only converted to specific forms upon determination of the data source.

In one embodiment, the method selects the appropriate data source for the query. In some embodiments, the method may have a pre-defined set of data sources for a give domain. That is, the data source may be associated with the formal grammar during processing. Alternatively, the method may dynamically select the data source based on the properties of a query. For example, the method may determine the type of data requested and select a data source capable of providing the requested information.

The step of translating a query may be performed by a data connector associated with each data source. Thus, after identifying a data source, the method may transmit the internal query to the data source which may in turn convert the internal query to an external query. In this manner, the connector and the systems generating the internal query may be separated and upgraded or modified independently as they share a common interface—the internal query form.

As an example, the method may identify that a first query interpretation must be handled by a relational database on a corporate network and thus the associated data connector may translate the internal query to an SQL statement, establish a network request with the database engine, and transmit the query. Alternatively, or in conjunction with the foregoing, the method may determine that the query interpretation should be handled by a remote HTTP API. In this case, the method may build an HTTP request (including POST or GET parameters) and issue the HTTP request to the API endpoint.

In step 405, the method executes the query at an external data source.

As mentioned above, after translating the query into an external form (e.g., SQL, HTTP request, etc.), the method then executes the query. In one embodiment, this may comprise establishing a connection with a database and issuing an SQL statement. Alternatively, this may include issuing an HTTP request to an endpoint as discussed above.

In step 406, the method receives and parses the result set returned by the external data source.

In response to the query, the method receives a result set and parses the result set. In one embodiment, the receipt and parsing of results sets is also handled by the data connector, thus encapsulating data source-specific behavior entirely within the data connector.

In one embodiment, the method may “clean” and normalize the returned data. Notably, the method may convert all returned data into a standardized format (e.g., generic arrays of hash objects) for later processing. Additionally, for some data sources, the method may attempt to clean any duplicative or otherwise dirty data. In some embodiments, the method may cache the returned data in a local database for future re-use.

Note that while described in the context of a single request, in some embodiments, the method may issue multiple requests for a single query. For example, a query may request data regarding mobile phones sold by multiple vendors. In one instance, each vendor may be associated with a separate data source. For example, one data source may comprise a relational database operated by a first vendor (that also runs the search engine). Thus, the method may generate a first external query corresponding to an SQL operation for this internal source. Alternatively, another HTTP endpoint may store data for all other vendors. Thus, the method may generate a second external query to retrieve this additional data.

Further, as described above, the method may normalize the return data. For example, the data returned from the relational database may be very detailed due to the co-ownership of the data. Conversely, data from remote sources may be less detailed and may also include overlapping data with the relational database data. Thus, the method may attempt to find a “common denominator” data set that ensure that the result set is not sparse (i.e., may find overlapping attributes). Additionally, the method may remove data in the remote data source that appears within the relational database data set to avoid duplicate entries.

FIG. 5 is a flow diagram illustrating a method for automatically selecting a visualization for a data set according to some embodiments of the disclosure.

In step 501, the method receives a result data set. As described above, the result data set comprises the results of executing the external query at one or more data sources.

In step 502, the method extracts features from the result data set.

In one embodiment, features comprise information regarding the structure of the data within the result data set. For example, a feature may comprise the number of columns in the data set and the datatype of each column. In some embodiment, a feature may comprise a partial feature that describes a subset of the total columns and associated data types.

Alternatively, or in conjunction with the foregoing, the features may comprise detail regarding the number of rows in the result data set as well as the content stored in each row.

In step 503, the method identifies a set of top visualizations for the result data set based on the features of the result data set.

In one embodiment, the selection in step 503 is performed using a Case-Based Reasoning (CBR) approach, which is a reasoning method used to solve new problems based on the solutions of similar past problems.

Using CBR, visualizations that were successfully applied in the past are retained as cases in the CBR system. A case is represented by a problem specification and a solution. The problem specification contains information about the data to which the visualization was applied (e.g. the label of each column, the data type of each column, statistical information about the data of each column, etc.). The solution contains the information needed to build the visualization (e.g. the chart type, the axes to be used, the series to be used, etc.).

In one embodiment, the visualization selection process in step 503 corresponds to the CBR retrieval phase. That is, the method receives the result set data (e.g., the problem in CBR) and the method must select the best visualization possible for that data (e.g., the solution). Using the problem specification, the method selects a case from the case base that matches the current problem using a similarity function. The similarity function is a weighted difference between the features of the problem and the features of the case. When a case is found, the solution of that case is adapted to solve the current problem. This means that if the method identifies a similar problem, or similar data, the method may use the same solution, or visualization, that was successfully used in the past.

Sometimes, when applying a visualization, the method may only use some of the dimensions, or columns, that are represented in the data (e.g. if grouping sales by country and region, but when using a pie chart can only two dimensions may be displayed, so the method chooses either the country or the region). This requires the data to be processed in order to merge repeated values in the x-axis (e.g. merge all the values that correspond to the different regions of each country when choosing only the country dimension). Using a rule-based process, the method may select a merge strategy for the data, either using the same aggregator operation that was being used in the query (e.g. sum the different values) or a different one according to the characteristics of the data. In one embodiment, the selection of a proper visualization may be limited to the visualizations that can be applied to the data that is being analyzed, which were determined during the previous visualization analysis step. In another embodiment, the user selects the type of visualization to use beforehand. In this embodiment, the method automatically filters the case base for cases that apply that type of chart, instead of searching any type of visualization.

As part of step 503, the method may additionally perform further steps when the selected visualization is a histogram chart, because the values must be distributed in different bins, which must be created automatically. In one embodiment, the method chooses the number of bins and their distribution according to a predefined formula that uses statistical information about the data itself.

Alternatively, or in conjunction with the foregoing, the method also paginates the results to avoid overloaded visualizations. It is typically unfeasible to show all the data that is returned by a query in a single visualization, both because the visualization would become unreadable and because of performance issues. In this scenario, the method applies a pagination process to a set of specific visualizations (e.g., bar charts, line charts, and scatter plot charts). The method may further split the data into individual blocks, or pages, that can be visualized sequentially. The size and limits of each page are determined using a set of rules based on the data and on the aggregators that may have been used in the query (e.g. when data is aggregated by month, each page will correspond to an entire year).

In another embodiment, the visualization selection process can also be personalized and learned over time. This personalization and learning is possible due to the use of a CBR approach in combination with maintaining a different case base for each user. That way, when the users select a specific visualization for the data, that action will trigger the creation of a new case in their individual case base. The cases that are created for each user will extend their case base and will be used in the future when selecting a visualization for a query of that specific user.

In step 504, the method transmits one or more visualizations to a user.

In one embodiment, the visualization may be transmitted as functionality within a webpage (e.g., implemented as JavaScript code, optionally, with graphics and other display elements for rendering the visualization). Alternatively, or in conjunction with the foregoing, the return visualization may simply comprise the data points for the visualization which may be utilized by a client-side rendering application (e.g., Chart.JS) or similar application. While described primarily in the context of webpages, the returned visualization is not limited strictly thereto. For example, the return visualization may be embedded within any application that supports the rendering of graphic content. For example, a word processing application may be configured with an “add-in” capable of issuing the natural language query and generating visualizations within the word processing application itself.

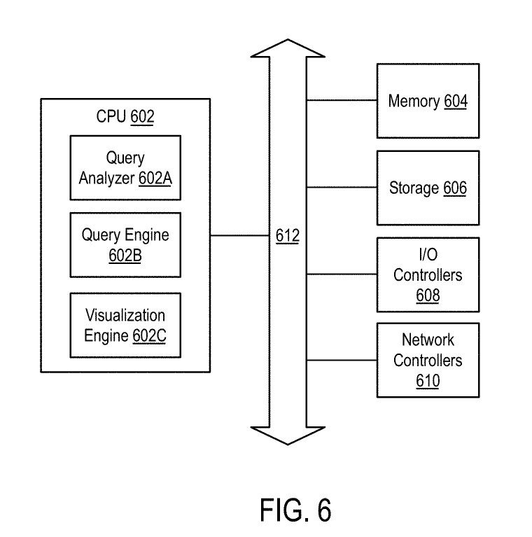

FIG. 6 is a hardware diagram illustrating a device for generating visualizations based on natural language queries according to some embodiments of the disclosure.

As illustrated in FIG. 6, a device includes a CPU 602 that includes query analyzer 602A, query engine 602B, and visualization engine 602C processes. CPU 602 may comprise an application-specific processor, a system-on-a-chip, a field programmable gate array (FPGA), a microcontroller or any suitable processing device. In some embodiments, the device may be implemented as a standalone server. Alternatively, or in conjunction with the foregoing, the device may be implemented as a virtual machine or serverless computing device. In one embodiment, query analyzer 602A, query engine 602B, and visualization engine 602C may perform the functions discussed previously and, in some embodiments, may correspond to query analyzer 102, query engine 103, and visualization engine 104 discussed in connection with FIG. 1. Although illustrated as including query analyzer 602A, query engine 602B, and visualization engine 602C, in some embodiments CPU 602 may only execute one or some of query analyzer 602A, query engine 602B, and visualization engine 602C processes.

Applications corresponding to processes 602A-602C may be stored in memory 604 and may be loaded by CPU 602 via bus 612. Memory 604 includes RAM, ROM, and other storage means. Memory 604 illustrates another example of computer storage media for storage of information such as computer readable instructions, data structures, program modules or other data. Memory 604 stores a basic input/output system (“BIOS”) for controlling low-level operation of the device. The mass memory also stores an operating system for controlling the operation of the device in some embodiments. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Storage 606 comprises a non-volatile storage medium. Storage 606 may store both inactive applications as well as user data. In some embodiments, storage 606 may comprise disk-based storage media, Flash storage media, or other types of permanent, non-volatile storage media.

The illustrated device additionally includes I/O controllers 608. I/O controllers 608 provide low level access to various input/output devices such as mice, keyboards, touchscreens, etc. as well as connective interfaces such as USB, Bluetooth, infrared and similar connective interfaces. In some embodiments, I/O controllers 608 may not be included in the device depending on the implementation environment.

The illustrated device additionally includes network controllers 610. Network controllers 610 include circuitry for coupling the device to one or more networks, and are constructed for use with one or more communication protocols and technologies. Network controllers 610 are sometimes known as transceivers, transceiving devices, or network interface cards (NIC).

Note that the listing of components of the illustrated device is merely exemplary and other components may be present within the illustrated device including audio interfaces, keypads, illuminators, power supplies, and other components not explicitly illustrated.

Note that in some embodiments, the device may further comprise a client device. In this embodiment, CPU 602 may not include query analyzer 602A, query engine 602B, and visualization engine 602C processes. Rather, CPU 602 may include various user applications such as a browser or other desktop applications (as discussed previously). Additionally, when configured as a user device, the device may include a display, user input devices, and other client-based computing devices.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

The subject matter described above may be embodied in a variety of different forms and, therefore, the application/description intends for covered or claimed subject matter to be construed as not being limited to any example embodiments set forth herein; example embodiments are provided merely to be illustrative. Likewise, the application/description intends a reasonably broad scope for claimed or covered subject matter. Among other things, for example, subject matter may be embodied as methods, devices, components, or systems. Accordingly, embodiments may, for example, take the form of hardware, software, firmware or any combination thereof (other than software per se). The description presented above is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. The application/description intends, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium that can be used to tangibly store the desired information or data or instructions and that can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a wired or wireless line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly.

A wireless network may further employ a plurality of network access technologies, including Wi-Fi, Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer-readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application that receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving a natural language query;
generating one or more parse trees based on the natural language query using one or more natural language processing procedures;
generating a structured query based on the one or more parse trees, the structured query generated based on an identified data source type;
executing a search on the data source using the structured query, the execution of the search resulting a result set;
identifying a visualization type based on a type of data included within the result set; and
generating a visualization based on the visualization type and the result set.

2. The method of claim 1, wherein the one or more natural language processing procedures include lexical, syntactical, and semantic procedures.

3. The method of claim 2, wherein the lexical procedures include one or more of a tokenization, stemming, part-of-speech tagging, plural identification, abbreviation expansion, entity recognition, stop word identification, and spell-checking procedure.

4. The method of claim 2, wherein the syntactical procedures include one or more of an object identification, attribute identification, value identification, Boolean operation identification, aggregation identification, period aggregation identification, distinct operator identification, comparator identification, and positive or negative operator identification procedures.

5. The method of claim 2, wherein the semantic procedures include one or more of an invalid interpretation detection, duplicate interpretation detection, repeat pattern detection, and ranking procedures.

6. The method of claim 1, wherein generating one or more parse trees comprises generating multiple parse trees and ranking the multiple parse trees using a genetic algorithm.

7. The method of claim 1, wherein generating a structured query further comprises:
expanding the one or more parse trees into an internal structured query; and
translating the internal structured query into the structured query based on identified data source type.

8. The method of claim 1, wherein identifying a visualization type further comprises:
analyzing data in the result set and a structure of the data in the result set to identify a set of features associated with the result set; and
identifying a set of visualization candidates associated with the set of features using a set of rules associating features to visualization candidates.

9. The method of claim 8, further comprising selecting one of the visualization candidates using a Case-Based-Reasoning approach.

10. A device comprising:
a processor; and
a non-transitory memory storing computer-executable instructions therein that, when executed by the processor, cause the device to perform the operations of:
receiving a natural language query;
generating one or more parse trees based on the natural language query using one or more natural language processing procedures;
generating a structured query based on the one or more parse trees, the structured query generated based on an identified data source type;
executing a search on the data source using the structured query, the execution of the search resulting a result set;
identifying a visualization type based on a type of data included within the result set; and
generating a visualization based on the visualization type and the result set.

11. The device of claim 10, wherein the one or more natural language processing procedures include lexical, syntactical, and semantic procedures.

12. The device of claim 11, wherein the lexical procedures include one or more of a tokenization, stemming, part-of-speech tagging, plural identification, abbreviation expansion, entity recognition, stop word identification, and spell-checking procedure.

13. The device of claim 11, wherein the syntactical procedures include one or more of an object identification, attribute identification, value identification, Boolean operation identification, aggregation identification, period aggregation identification, distinct operator identification, comparator identification, and positive or negative operator identification procedures.

14. The device of claim 11, wherein the semantic procedures include one or more of an invalid interpretation detection, duplicate interpretation detection, repeat pattern detection, and ranking procedures.

15. The device of claim 10, wherein generating one or more parse trees comprises generating multiple parse trees and ranking the multiple parse trees using a genetic algorithm.

16. The device of claim 10, wherein generating a structured query further comprises:
expanding the one or more parse trees into an internal structured query; and
translating the internal structured query into the structured query based on identified data source type.

17. The device of claim 10, wherein identifying a visualization type further comprises:
analyzing data in the result set and a structure of the data in the result set to identify a set of features associated with the result set; and
identifying a set of visualization candidates associated with the set of features using a set of rules associating features to visualization candidates.

18. The device of claim 17, further including instructions causing the device to perform the operation of selecting one of the visualization candidates using a Case-Based-Reasoning approach.

19. A system comprising:
a query analyzer comprising at least one server configured to receive a natural language query and generate one or more parse trees based on the natural language query using one or more natural language processing procedures;
a query engine comprising at least one application server configured to generate a structured query based on the one or more parse trees, the structured query generated based on an identified data source type and execute a search on the data source using the structured query, the execution of the search resulting a result set; and
a visualization engine comprising at least one application server configured to identify a visualization type based on a type of data included within the result set and generate a visualization based on the visualization type and the result set.

20. The system of claim 19, further comprising a plurality of data connectors, wherein the data connectors are configured to expand the one or more parse trees into an internal structured query and translate the internal structured query into the structured query based on identified data source type.
